(19) United States
(12) Patent Application Publication
(10) Pub. No.: US 2009/0053997 A1
(43) Pub. Date: Feb. 26, 2009

(54) DYNAMIC USER INTERFACE FOR DISPLAYING CONNECTION STATUS AND METHOD THEREOF

(75) Inventors: Jeremy T. Jobling, Deerfield, IL (US); Joonwoo Park, Chicago, IL (US); Jeremy S. Slocum, Antioch, IL (US)

Correspondence Address: MOTOROLA INC.;C/O VEDDER PRICE P.C., 222 N. LASALLE ST, CHICAGO, IL, 60601, US

(73) Assignee: Motorola, Inc., Schaumburg, IL (US)

(21) Appl. No.: 11/844,592

(22) Filed: Aug. 24, 2007

(51) Int. Cl. H04B 7/00; G05B 19/00

(52) U.S. Cl. 455/41.2; 340/825.22

(57) ABSTRACT

A method for providing a user interface for a device (300) includes determining a capability of a remote device, selectively enabling at least one of a plurality of different control structures (404, e.g., 302, 310, etc.), each with corresponding visual indication (406) of connectivity status based on a connection occurring and determined capability of the remote device. The method may also include selectively enabling a second control structure (404, e.g., 302, 310, etc.) of the plurality of different control structures, the second control structure also with corresponding visual indication (406) of connectivity status. The method may also include selectively disabling at least one of the plurality of different control structures (404, e.g., 302, 310, etc.) with corresponding visual indication (406) of connectivity status based on a change in a connection status. Furthermore, a device 300 may implement the disclosed methods.

### FIELD OF THE DISCLOSURE

The disclosure relates generally to electronic devices and more particularly to electronic devices that employ a user interface.

### BACKGROUND OF THE DISCLOSURE

Electronic devices, such as computers, media, e.g., music, players, laptops, wireless handheld devices such as cell phones, digital music players, palm computing devices, or any other suitable devices are increasingly becoming widespread. Improved usability of such devices can increase sales for sellers as consumer demand can be driven by differing device usability characteristics and device features. Furthermore, as technology advances, new features continue to be added to electronic devices, which are also becoming smaller. As more features are added to smaller devices, however, users must be able to more easily (and more frequently) interact with such devices via understandable and efficient means.

Morphable user interfaces are thus beginning to be an important design consideration for the next generation of electronic devices. A morphable user interface is one that changes its appearance as the use of the device changes (e.g., from phone to camera to music players etc.). For example, morphing may make only certain controls available based on a current characteristic of the device, such as its operating state or orientation. Users of a device using morphing technology will find the input interface simpler and more intuitive to use.

FIGS. 1 and 2 show one prior art device 100 that uses morphing. In FIG. 1, device 100 has a display 102; directional input buttons 104, 106, 108, and 110, one or more select input buttons 112; and a morphing button 114. A morphing button, such as morphing button 114, is a control structure that has a change (e.g., it's availability changes; it's location changes, it's functionality changes, etc.) based on a condition (e.g., the orientation of the device, the availability of a device's features, the user's previous input, etc.). FIG. 2 shows device 100, which also includes a display 102; directional input buttons 104, 106, 108, and 110; a select input button 112; and morphing button 114. FIG. 2 also depicts speaker 202, which slidably extends from within device 100. When the speaker 202 is slidably extended, morphing button 114 changes its location, but the functionality remains the same. This morphing may be useful because a user may be likely to hold device 100 in a vertical orientation when speaker 202 is not extended, in which case the user may be accustomed to always having morphing button 114 towards the top-left of the directional input buttons 104, 106, 108, and 110. When the device has the speaker 202 extended, however, a user is more likely to hold the device 100 in a horizontal orientation. By morphing the morphing button 114 to change its location, its relative location to the directional input buttons 104, 106, 108, and 110 from the perspective of the user will remain the same, i.e., to the top-left of the directional input buttons 104, 106, 108, and 110.

Another morphing technology known in the art involves changing the availability of user interface control structures (e.g., buttons) on what the user is doing and/or the current state of a device. In devices using this particular morphing technique, the control structures never change location, but the availability, e.g., on/off status, of the control structures may change. For example, a music player may have a play and a pause button. If the music player is in a play state or mode, i.e., it is playing music, the music player's user interface may morph by disabling the play button and enabling the pause button. If a user selects the pause button, thereby pausing the operation of the music player, the user interface may morph by enabling the play button and disabling the pause button. As known in the art, such devices may include a touch panel laid over a series of LEDs. The on/off functionality may thus be controlled by turning LEDs on or off to achieve the desired morphing effects, i.e., to change the availability (or apparent availability) of buttons on the user interface.

Another related technology often used on cell phones is the concept of soft keys. Note, however, that although reminiscent of morphing technology, soft keys are not a morphing technology. A soft key is a key on a device that may have more than one functionality depending on the mode or state of the phone. In other words, if a user presses a soft key, the phone may do any number of different functions depending on what mode the phone is in. The device's display often contains a label to inform a user what function the soft key will perform based on the current mode or state of the phone. Thus, the label telling the user what operation the button will perform is separate from the functional button. One problem with soft keys, however, is that users must mentally map the button to the label displayed on the screen, i.e., a person must look at the screen for the indication as to the functional operation of a soft key. Many users are accustomed to having the label on the functional button itself. For example, a user of a television remote control may press the button labeled “3” in order to “input” the number three into a television system. Thus, some users find soft keys confusing.

Another technology that one skilled in the art might compare to morphing technology is touch screens. As well known in the art, a touch screen may change the displayed images based on the operational mode or state of the device. This operational mode or state may be influenced, for example, by the user input it receives. For example, a touch screen may display a menu of items that a user may select, perhaps leading to a sub-menu based on the particular menu item the user selects. The sub-menu, however, may be different based on the user input or other characteristics of the device. Touch screens are not without problems, however. For example, touch screens tend to be expensive, and touch screens are not always feasible to implement in electronic devices, especially in smaller electronic devices. Furthermore, touch screens contain a full LCD matrix, and all user control must occur within that LCD matrix. Thus, button location is more flexible by not using touch screens, a characteristic that can be important as designers attempt to place more functionality (and more buttons) on smaller devices. Additionally, touch screens do not offer other benefits, such as haptic feedback. For stylus-driven touch screens, the user must use two hands to control the device, which can be disadvantageous, and for finger-driven touch screens, the screens are typically large and unsuitable for use in mobile devices.

Accordingly, it is desirable to provide an electronic device having an improved morphing user interface. Furthermore, other desirable features and characteristics of the present disclosure will become apparent form the subsequent detailed description and the appended claims, taken in conjunction with the accompanying drawings and this background.

### BRIEF DESCRIPTION OF THE DRAWINGS

The present invention and the corresponding advantages and features provided thereby will be best understood and appreciated upon review of the following detailed description of the invention, taken in conjunction with the following drawings, where like numerals represent like elements, in which:

FIG. 1 is a prior art device with a morphing button;

FIG. 2 shows the prior art device of FIG. 1 with the morphing button in a different location;

FIG. 3 shows an electronic device having a plurality of different control structures in accordance with one aspect of the disclosure;

FIG. 4 is a block diagram of some components in an electronic device in accordance with one aspect of the disclosure;

FIG. 5 shows a portion of the electronic device of FIG. 3, focusing on a user interface portion of the electronic device in accordance with one aspect of the disclosure;

FIG. 6 shows a portion of the electronic device of FIG. 3, focusing on a user interface portion of the electronic device in accordance with one aspect of the disclosure;

FIG. 7 shows a portion of the electronic device of FIG. 3, focusing on a user interface portion of the electronic device in accordance with one aspect of the disclosure;

FIG. 8 shows a portion of the electronic device of FIG. 3, focusing on a user interface portion of the electronic device in accordance with one aspect of the disclosure;

FIG. 9 shows a portion of the electronic device of FIG. 3, focusing on a user interface portion of the electronic device in accordance with one aspect of the disclosure;

FIG. 10 shows a portion of the electronic device of FIG. 3, focusing on a user interface portion of the electronic device in accordance with one aspect of the disclosure;

FIG. 11 shows a portion of the electronic device of FIG. 3, focusing on a user interface portion of the electronic device in accordance with one aspect of the disclosure;

FIG. 12 is a flow chart showing a method for providing a user interface for a device in accordance with one aspect of the disclosure; and

FIG. 13 is a flow chart showing a more detailed method for providing a user interface for a device in accordance with one aspect of the disclosure.

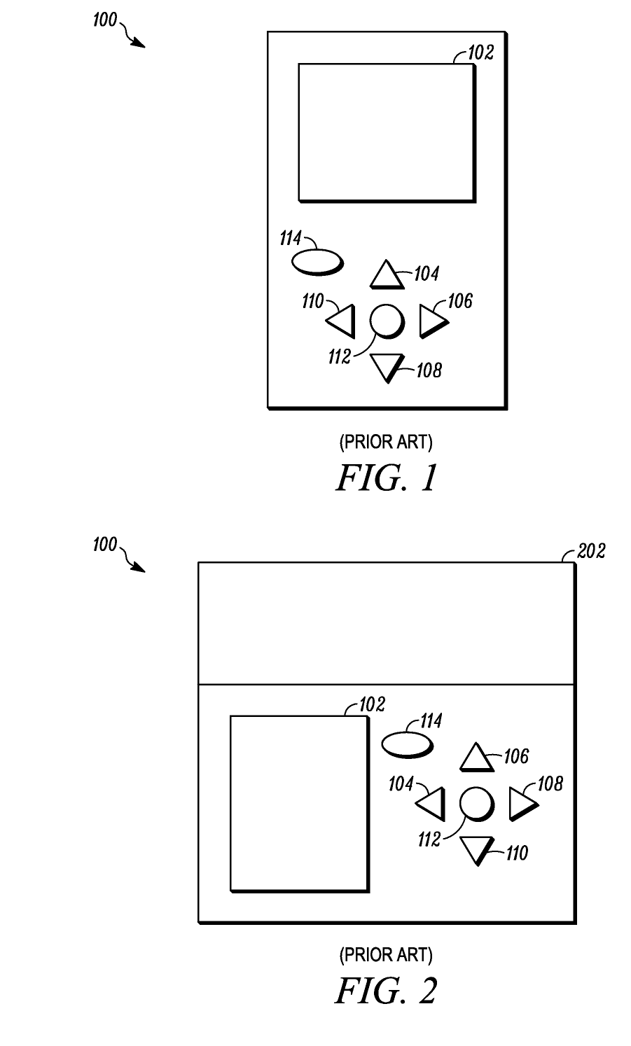

### DETAILED DESCRIPTION

The following detailed description is merely exemplary in nature and is not intended to limit the subject matter or the application and uses of the disclosure. Furthermore, there is no intention to be bound by any theory presented in the preceding background section or the following detailed description. Instead, the disclosure within will provide one skilled in the art a convenient road map for implementing the disclosure, it being understood that various changes may be made in the function and arrangement of elements or methods described without departing from the scope or spirit of the disclosure as set forth in the appended claims.

An electronic device has a plurality of different control structures, each with corresponding visual indication of connectivity status with a remote device such as short range wireless headset or other device. Control logic, operatively coupled to the plurality of different control structures and corresponding visual indications, is operative to selectively enable one of the plurality of different control structures with corresponding visual indication of connectivity status based on a connection occurring with the remote device and determined capability of the remote device. The control logic may also selectively enable, based on a change in a connection status between the electronic device and the remote device, a second control structure of the plurality of different control structures, which also has a corresponding visual indication of connectivity status. Furthermore, the control logic may be operative to selectively disable at least one of the plurality of different control structures with corresponding visual indication of connectivity status based on a change in a connection occurring.

A method for providing a user interface for a device, such as a docking station or other device, is also described within. The method includes determining a capability of a remote device and selectively enabling at least one of a plurality of different control structures, each with corresponding visual indication of connectivity status based on a connection occurring and determined capability of the remote second device. The method may also include selectively enabling, based on a change in a connection status between the device and the remote device, a second control structure with corresponding visual indication of connectivity status. Furthermore, the method may include selectively disabling at least one of the plurality of different control structures with corresponding visual indication of connectivity status based on a change in a connection status. It is also contemplated that the method may include sending a command to the remote device when a user activates one of the plurality of different control structures.

Thus, many advantages will be apparent to one skilled in the art. For example, by enabling a control structure for a user interface based on a connection occurring and the capabilities of a remote device, a user will be less likely to attempt to activate a disabled control structure, which could lead to user confusion. Furthermore, the disclosed method and device do not have the disadvantages commonly associated with touch screens, which can be expensive and must acquire all user input within a set area—the LCD matrix of the touch screen. Other advantages will be apparent to one skilled in the art.

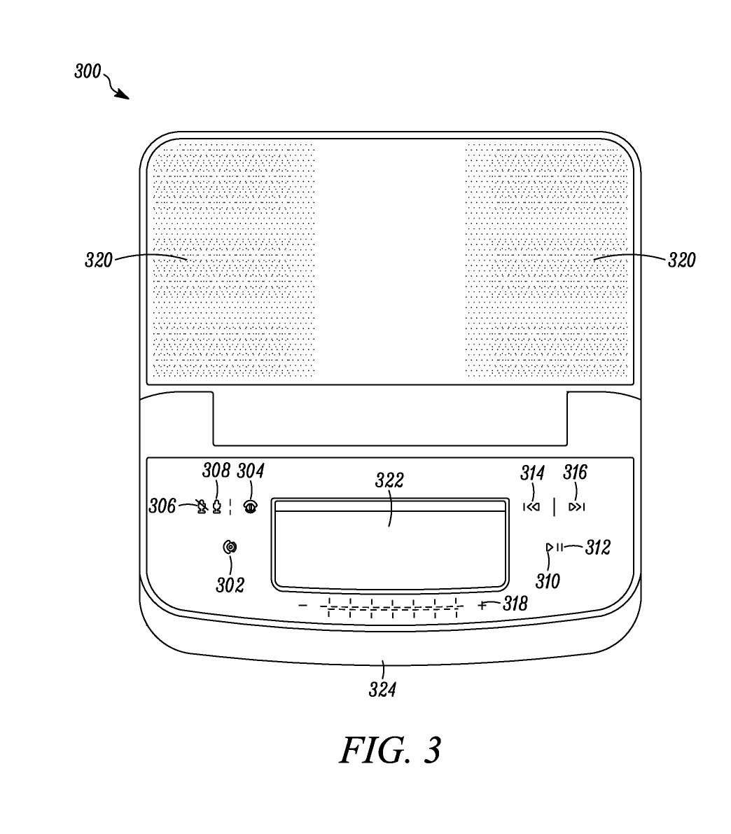

FIG. 3 shows an electronic device 300 with a plurality of different control structures with connectivity status indication 302-316, which each have corresponding visual indication of connectivity status with a remote device. In particular, the control structure with connectivity status 302 in this particular example is a send button, control structure with connectivity status 304 is an end button, control structure with connectivity status 306 is a mute button, control structure with connectivity status 308 is an unmute button, control structure with connectivity status 310 is a play button, control structure with connectivity status 312 is a pause button, control structure with connectivity status 314 is a track back button, and control structure with connectivity status 316 is a track forward button. The device may also include volume controls 318, which may include one or more buttons, sliders, or any other suitable mechanism as known in the art; one or more speakers generally designated 320; and a charging connection/drawer 322. These features, among others, may be coupled to a housing 324. Note that the particular control structures and their labels may vary upon particular implementation. In this particular example, control structures 302 and 304 are referenced as and labeled with terms and icons commonly associated with cell phones. Control structures 310, 312, 314, and 316 contain labels (indicia) that users commonly associate with music playback. It should be understood, however, that these buttons and labels were chosen for illustrative purposes only and that the functions they represent and ways in which they are represented may be of any suitable nature. It should also be noted that the plurality of control structures with connectivity status indication 302, 304, 306, 308, 310, 312, 314, or 316 may not all be available, visible, and/or functional at the same time. For example, mute button 306 would most likely not be available when unmute button 308 is active. FIG. 3, however, depicts all control structures potentially available in this example embodiment, however, so that a reader will better understand the user interface morphing capabilities of this disclosure in the subsequent figures. Finally, the housing 324 may take the form of a docking station, which, as already noted, may also contain a charging connection/drawer 322, or may take any other suitable configuration.

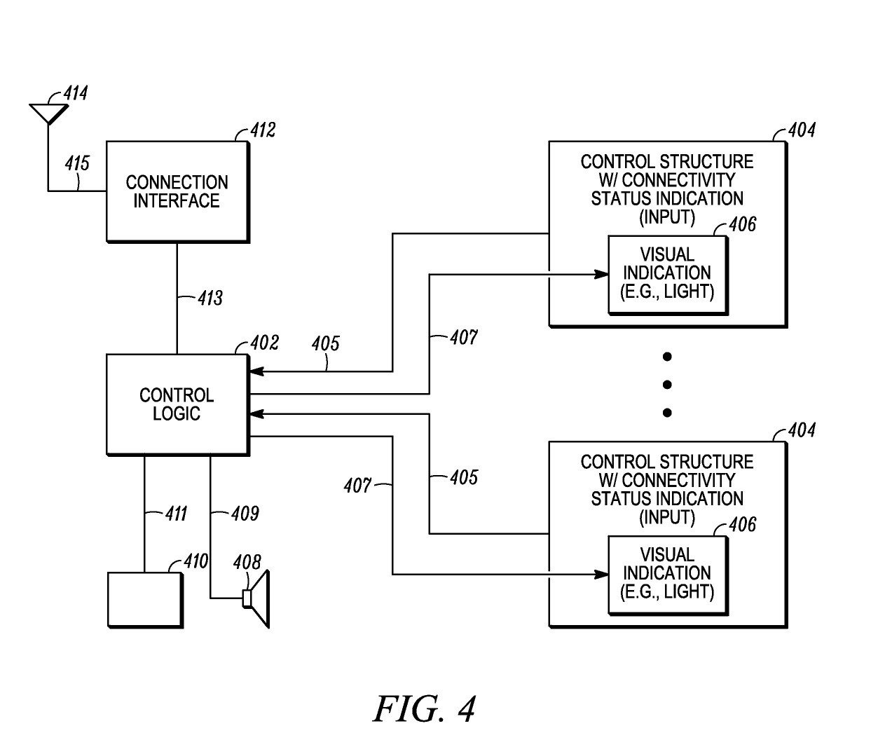

Turning now to FIG. 4, a schematic is shown to help describe how an electronic device 300 may operate. Control logic 402 is operatively coupled to the plurality of different control structures with connectivity status, generally designated 404, via link 405 that transmits control structure with connectivity status indication data. The control structures with connectivity status 404 may be, for example, non-touch screen control structures and may be operative to receive user input. The control structures with connectivity status 404 may include any suitable activation structure separate from the connectivity status indication, such as a button, a knob, a key, a slider, a tactile sensing device, or any other suitable control structure. Preferably, however, the control structure with connectivity status indication 404 is not visible to a user when it is not active. Thus, for example, the control structure might include a touch panel laid over LEDs. It should further be understood that a user may use a control structure with various types of interaction, such as physical interaction, to perform various types of input. For example, a user may touch, turn, slide, push, push and hold, press multiple times within a designated time period, pass and sweep, or use any other suitable interaction now known or later developed for a user to provide input to an electronic device 300.

Each control structure with connectivity status 404 has corresponding visual indications 406, which may include, for example, an illumination source (e.g., LEDs, lightpipe, etc.) and indicates a connectivity status with a remote device. Thus, for example, if a control structure with connectivity status 404 is enabled, the corresponding visual indication 406 is activated to indicate to a user that the particular control structure is active and that the remote device is connected to communicate information with device 300. Similarly, if a control structure with connectivity status 404 is disabled, the corresponding visual indication 406 may also be disabled or otherwise changed to indicate that the control structure with connectivity status 404 is not enabled.

Additionally, the visual indication may indicate the connection type, such as a short range wireless link such as Bluetooth®, WiFi, or infrared, wired, etc.; a signal strength, a remote device type, such as music player, cell phone, etc.; a remote device ID (so that a user may be able to distinguish, for example, whether the connection is with cell phone A or cell phone B); or a battery level of the remote device. For example, if the remote device's battery begins to reach a low level, one of the visual indications corresponding to a control structure is controlled to flash or dim. As another example, if the connection is via Bluetooth®, the visual indication could be a blue light, but if the connection is via a wired connection, the visual indication is changed to a different color, such as using a red light.

Control structure with connectivity status 404 and corresponding visual indication 406 are both operatively coupled to control logic 402: control structure with connectivity status indication via link 405 (transmitting control structure connectivity status indication data) and visual indication via link 407 (transmitting visual indication data). It should be understood that control logic 402 may be implemented by any suitable means. For example, the control logic may be one or more processing devices coupled to computer readable memory (not shown), wherein the memory contains executable instructions that, when executed by the one or more processing devices, cause the processors to perform the desired functions described herein. As one skilled in the art will appreciate, however, control logic 402 could also be implemented with finite state machines, discrete logic, or any other suitable means now known or later developed. As further described within, control logic 402 may, for example, be operative to selectively enable one of the plurality of different control structures with connectivity status 404 with corresponding visual indication of connectivity status based on a connection occurring with a remote device and determined capability of the remote device. Control logic 402 may also be operatively coupled to one or more speakers 408 via link 409, which may transmit audio information, and a microphone 410 via link 411, which may transmit microphone signals, or other components.

Additionally, control logic 402 may also be operatively coupled to a connection interface 412 with a connecting link 413. Connection interface 412 may be any suitable interface operative to communicate with a remote device, which may be, for example, a cell phone, a music player, a video player, or any other suitable device. The connection interface allows the electronic device 300 to communicate via one or more now known or later developed methods, both wired and/or wireless. In this particular example, connection interface 412 is shown coupled to an antenna 414 with link 415 for wireless communication. The wireless communication may be, for example, via a short range wireless method. As already noted, connection interface 412 may also be coupled to a port (not shown) to communicate with a remote device via a wired connection. Thus, note that the term remote means that the remote device is a device separate from electronic device 300 capable of functioning on its own. It does not mean that the remote device must be distant. The remote device could, for example, be coupled to electronic device 300 via a cable, could be placed in the charging drawer 322, or could be otherwise connected to the electronic device 300.

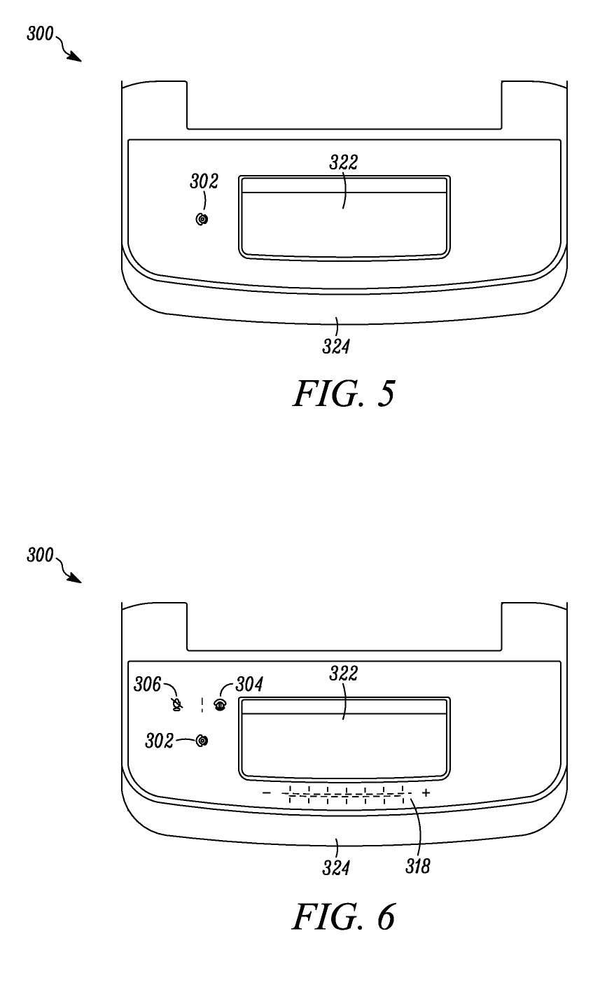

FIGS. 5-11 help better describe the device 300, by focusing in on a user interface portion of device 300 and more particularly showing how control logic 402 may selectively enable one of the plurality of different control structures with connectivity status 404 with corresponding visual indication of connectivity status based on a connection occurring with a remote device and determined capability of the remote device. For explanatory purposes, the connection interface 412 communicates via a short range transceiver such as a Bluetooth® connection, but it should be understood that any other suitable connection protocol or standard now known or later developed may be used. The connectivity status is based on (1) a connection occurring with a remote device and (2) a determined capability of the remote device. As known in the art, Bluetooth® standards set forth a handshaking procedure to pair one device, such as electronic device 300, with one or more other devices, such as a remote device. Thus, connection interface 412 may establish a connection with a remote device via a Bluetooth™ connection.

Then, during the pairing process, the devices exchange profiles, i.e., profile data, which indicate the capabilities of the devices. These profiles therefore enable modes of a device. As known and appreciated in the art, Bluetooth® profiles are an industry standard describing general behaviors through which Bluetooth® enabled devices may communicate, thereby allowing Bluetooth® devices developed by different developers to communicate with each other. For example, the hands-free profile (“HFP”) is commonly used to allow hands-free devices to perform two-way communication with a cell phone. The advanced audio distribution profile (“A2DP”) defines how high quality audio can be streamed from one device to another, such as from a music player or phone to a docking station or wireless headset. As another example, the audio/video remote control profile (“AVRCP”) provides a standard for controlling (remotely) various devices. AVRCP may provide, for example, controls for controlling the playing, pausing, changing tracks, etc. of a remote device. As such, the AVRCP profile is often used with the A2DP profile: for example, A2DP describes how a music player streams music to a wireless headset or wireless speakers and AVRCP allows the wireless headset or wireless speakers to have controls to control the music player. Thus, for example, control logic 402 may be operative to receive profile data associated with a remote device and configure the plurality of control structures based on the profile data, as is described throughout.

Turning to FIG. 5, control logic 402 has selectively enabled send button 302 based on a change in connection status (the electronic device 300 was not connected to a remote device but now is connected to a remote device) and the determined capability of the remote device. In this case, the determined capability of the remote device was phone communication. This determination could have been made, for example, by exchanging profiles and, in this case, the remote device could have exchanged a Bluetooth® HFP profile.

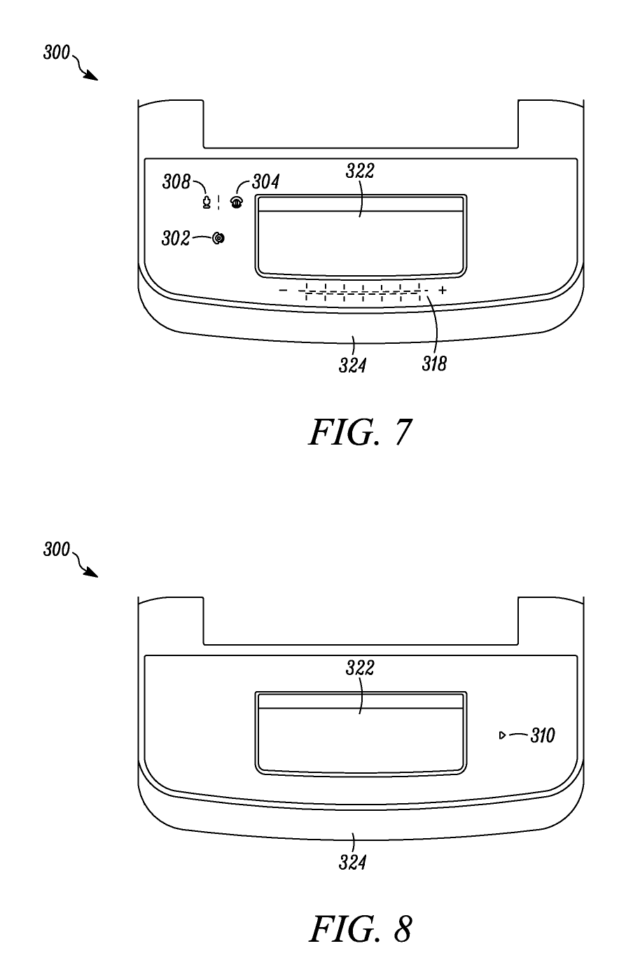

The showing of only send button 302 may also indicate to the user the state or mode that the remote device is in. For example, FIG. 6 also shows send button 302 (indicating a connection with a remote device and that the remote device is capable of phone communication). Control logic 402 has also enabled two additional control structures: end button 304 and mute button 306. As such, a user will be able to tell, for example, that the remote device is in a call state. Since a phone being in a call state provides additional operations (such as ending the call), control logic 402 enabled additional control structures. Also note that the mute button 306 is enabled in FIG. 6. Mute button 306 could cause the remote device to enter a mute mode or state, but mute button could also or alternatively mute the microphone on the electronic device 300. It is thus apparent that control logic 402 may enable control structures based on a connectivity status (a connection occurring and a determined capability of a remote device) and on the state or mode of either the remote device or the electronic device 300. Note, for example, that for send button 302, end button 304, and mute button 306 to be enabled, a connection must have occurred and the determined capability of the remote device must be that it is capable of telephone communication. FIG. 7 illustrates an example of the electronic device 300 after a user has controlled mute button 306. Control logic 402 has disabled mute button 306 and enabled unmute button 308.

As should be readily apparent based on the description herewith, each of these buttons just described is a control structure with connectivity status 404 that includes corresponding visual indications 406. These visual indications 406 may indicate that the connectivity status of a remote device (i.e., that a connection occurred and the determined capability of the device). The visual indications, however, may also indicate other information to a user. As one example, the visual indications may indicate a change in state or mode of the remote device. For example, if the remote device is a cell phone and there is an incoming call while the cell phone is in a call state, send button 302 may change its visual indication. For example, control logic 402 may cause send button 302 to flash, change color, change a flash rate, change its brightness, change shape, or vary the visual indication by any other suitable means to provide information to a user.

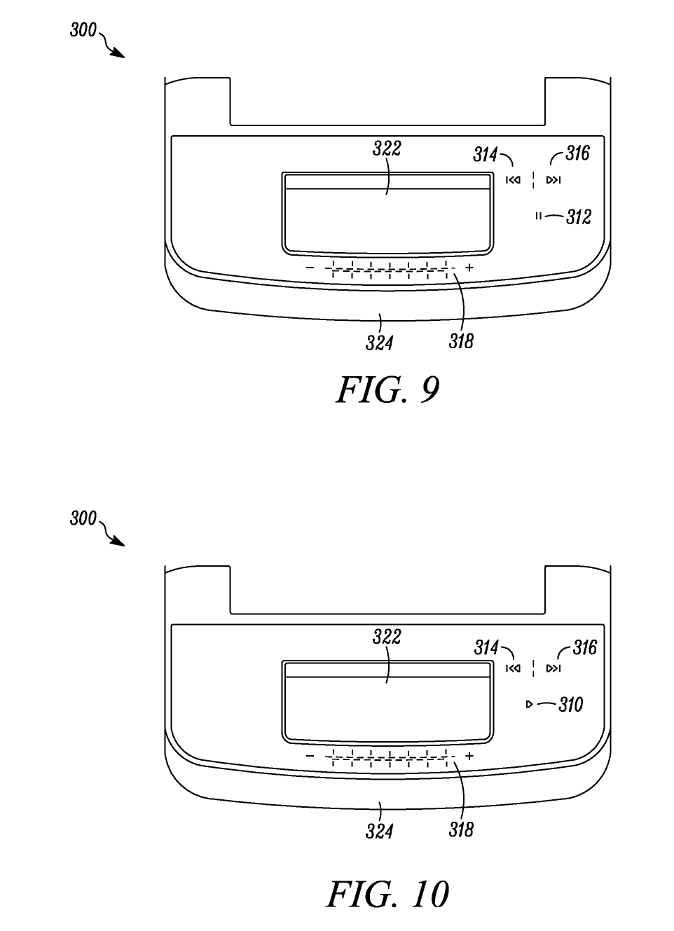

Turning now to FIG. 8, electronic device 300 is shown with the play button 310 control structure enabled. Thus, a user may readily see that a connection has occurred with a device that has audio playing capabilities (e.g., A2DP) (and the control thereof (e.g., AVRCP)). In this particular figure, a user may also be able to know that the remote device is in a standby state. Turning now to FIG. 9, electronic device 300 is still connected to a remote device that has A2DP and AVRCP profiles, for example, but the remote device is now in a play mode, i.e., it is playing music. This is apparent because control logic 402 has enabled pause button 312, track back button 314, and track forward button 316. It should be understood that any other suitable control structures could be enabled in these figures and that the figures showing enabled control structures are non-limiting illustrative examples. For example, the electronic device 300 in FIG. 9 could also have a stop button (not shown). FIG. 10 also shows electronic device 300 with the same connectivity status as that shown in FIG. 9 (connected to a device with audio playback capabilities and control thereof), but in this case, the remote device is in a pause mode. Thus, as shown, pause button 312 has been disabled and play button 310 has been enabled. Again, control logic 402, or any other suitable control logic, may enable and disable these control structures.

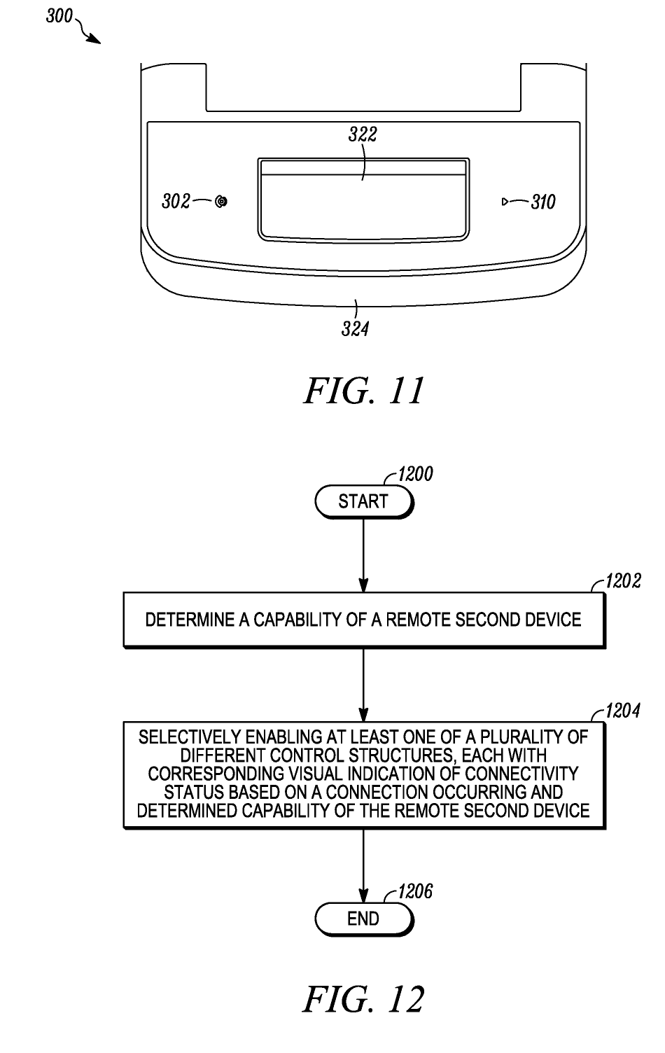

As shown in FIG. 11, the control logic 402 may also be operative to selectively enable, based on a change in connection status between the electronic device and the remote device, a second control structure of the plurality of different control structures, the second control structure with corresponding visual indication of connectivity status. In this particular example, a connection has occurred between device 300 and a second remote device, and the determined capabilities, determined for example by connection interface 412 and/or control logic 402, include the capabilities to perform phone communication (e.g., determined by an exchange of HFP profile data) and audio playback and control (e.g., determined by an exchange of A2DP and AVRCP profile data). Thus, as shown, control logic 402 has enabled send button 302 and play button 310. Consistent with the description above, the enabling of only these control structures may also indicated that the remote device is in a standby mode, i.e., the remote device is not in a call state and the remote device is not playing music. As one skilled in the art would understand, however, control logic 402 may enable additional control structures if the remote device or electronic device 300 change modes or states. For example, if play button 310, send button 302, end button 304, and mute button 306 are all enabled, a user may readily determine the following: (1) a connection has occurred with a remote device, (2) the determined capabilities of the remote device include hands-free phone calling and audio playback/control; (3) music is not playing; and (4) the remote device is in a call state. It should also be realized that the enabling of both send button 302 and play button 310 may occur either because there is a connection with one remote device having the both telephone capabilities and music playing capabilities or because device 300 is connected with a first device having telephone capabilities and a second device having music playing capabilities.

It should also be understood that the electronic device 300 is operative to send a command to the second remote device when a user activates one of the plurality of different control structures, as is described above. The sent command may cause the remote device to perform a desired function, such as play audio, play video, change a media source file (e.g., change songs, go to the next video), answer a phone call, place a phone call, or perform any other suitable or desired function or operation.

It should also be understood that control logic 402 is operative to selectively disable at least one of the plurality of different control structures with connectivity status 404 with corresponding visual indication 406 of connectivity status based on a change in a connection status. For example, if the electronic device appears as depicted in FIG. 5 but the connection between electronic device 300 and the remote device is lost, control logic 402 may disable send button 302. As such, a user would know that electronic device is not connected to a remote device.

Additionally, a method for providing a user interface for a device is disclosed. Although the circuit schematic of FIG. 4 may be used to carry out the method and the method may be used in the electronic device 300, it should be understood that the methods disclosed herein may use any suitable hardware or software or other suitable means to implement the method and furthermore that the method may be implemented on any suitable device. It should further be understood that the steps of the methods, although described in a particular order, may be implemented in any suitable order and may include additional steps before, intervening, or after the described steps.

Turning now to FIG. 12, a flowchart shows a method for providing a user interface for a first device and starts at block 1200. As shown in block 1202, the method includes determining a capability of a second device. As described above, for example, this may be done by control logic 402 and via a standard, such as by exchanging Bluetooth® profile data via connection interface 412. Next, as shown in block 1204, the method includes selectively enabling at least one of a plurality of different control structures, each with corresponding visual indication of connectivity status based on a connection occurring and determined capability of the remote second device. Thus, as described above for example, a user may look at a user interface provided by this method and know that a connection exists and have an indication of at least one of the capabilities of the remote device. It is additionally noted that this information is provided via a control structure (and its corresponding visual indication), thereby helping to reduce the possibility that a user may try to activate a control structure that may be disabled because the remote device does not perform a corresponding operation associated with the control structure on the first device. The method then ends as shown at block 1206.

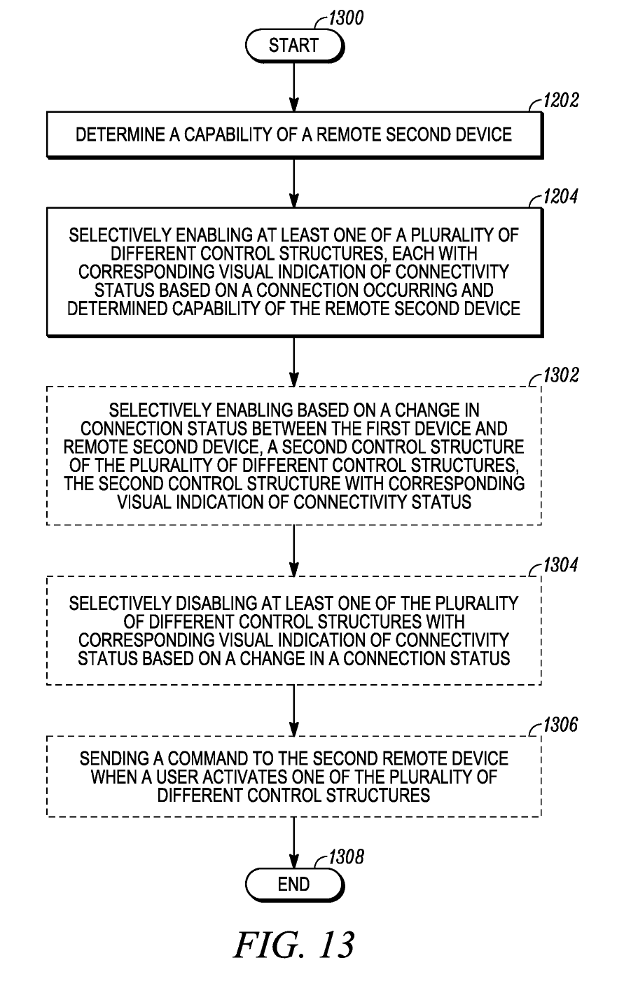

As already noted, the method may include additional steps. Some of these additional steps are illustrated as optional steps in FIG. 13 with the method starting at block 1300. This method may also contain, as illustrated, the steps illustrated in blocks 1202 and 1204. As shown in block 1302, the method may also include selectively enabling, based on a change in connection status between the first device and remote second device, a second control structure of the plurality of different control structures, the second control structure with corresponding visual indication of connectivity status. For example, in the examples given above, if an electronic device 300 establishes a connection with a remote device and the remote device has an HFP, control logic 402 selectively enables send button 302. It is also conceivable, however, that control logic 402 could also enable a second button (not shown), such as, for example, a disconnect button or even a full numeric keypad to place calls.

As shown in optional block 1304, the method may also include selectively disabling at least one of the plurality of different control structures with corresponding visual indication of connectivity status based on a change in a connection status. Thus, for example, if a connection is lost, the user will know there has been a change in connection status because the control structure will no longer be enabled. This can help prevent consumer confusion because, by disabling the control structure, a user will be less likely to attempt to activate a control structure that no longer has any functionality.

Another optional step is shown in block 1306, which may occur before the end of the method in block 1308. As shown in block 1306, the method may include sending a command to the second remote device when a user activates one of the plurality of different control structures. As discussed above, this step may allow, for example, a user of the user interface in the first device to activate one of the plurality of control structures to cause the remote device to perform an operation or function, such as placing a call, ending a call, playing a music track, moving to the next or previous music track, or performing any other suitable function of a remote device as one of ordinary skill in the art will appreciate.

Among other advantages, an electronic device having a plurality of control structures and corresponding visual indications selectively enabled based on connectivity status (i.e., a connection occurring and the determined capability of a remote device) provides a user interface that informs the user what operations the remote device may be capable of performing and only presents the user with enabled control structures for which a corresponding operation or function is available. Thus, the user interface can avoid user confusion, which often results in other designs because the control structures still appear enabled even if the corresponding operations or functions are no longer available (perhaps because of a loss of a connection or because the remote device cannot perform the function corresponding to the button). For example, if the remote device is a music player without phone capabilities, a user may attempt to activate the send key if it is enabled, thereby causing confusion when nothing happens. The present disclosure also avoids the disadvantages with touch screens. For example, the plurality of control keys may be located on one or more outer surfaces of the housing, whereas with a touch screen, and input “buttons” on the touch screen must be within the LCD matrix. Furthermore, the device may not even contain a display in light of the disclosure. Other advantages and modifications within the scope and spirit of this disclosure will be recognized by one skilled in the art.

The above detailed description of the invention, and the examples described therein, has been presented for the purposes of illustration and description. While the principles of the invention have been described above in connection with a specific device, it is to be clearly understood that this description is made only by way of example and not as a limitation on the scope of the invention.

What is claimed is:

1. A method for providing a user interface for a first device comprising:
determining a capability of a remote second device;
selectively enabling at least one of a plurality of different control structures, each with corresponding visual indication of connectivity status based on a connection occurring and determined capability of the remote second device.

2. The method of claim 1 including:
selectively enabling, based on a change in a connection status between the first device and remote second device, a second control structure of the plurality of different control structures, the second control structure with corresponding visual indication of connectivity status.

3. The method of claim 1 including:
selectively disabling at least one of the plurality of different control structures with corresponding visual indication of connectivity status based on a change in a connection status.

4. The method of claim 1 including:
sending a command to the second remote device when a user activates one of the plurality of different control structures.

5. The method of claim 1 wherein the visual indication further indicates at least one of the following: a connection type, a signal strength, a remote device type, a remote device ID, and a battery level of the remote device.

6. An electronic device comprising:
a plurality of different control structures, each with corresponding visual indication of connectivity status with a remote device;
control logic, operatively coupled to the plurality of different control structures and corresponding visual indications, operative to selectively enable one of the plurality of different control structures with corresponding visual indication of connectivity status based on a connection occurring with the remote device and determined capability of the remote device.

7. The electronic device of claim 6 wherein the control logic is operative to selectively enable, based on a change in a connection status between the electronic device and the remote device, a second control structure of the plurality of different control structures, the second control structure with corresponding visual indication of connectivity status.

8. The electronic device of claim 6 wherein the control logic is operative to selectively disable at least one of the plurality of different control structures with corresponding visual indication of connectivity status based on a change in a connection status.

9. The electronic device of claim 6 further comprising a connection interface operatively coupled to the control logic and operative to communicate with the remote device.

10. The electronic device of claim 9 wherein the connection interface may communicate with the remote device via at least one of the following: a short range wireless communication interface and a wired communication interface.

11. The electronic device of claim 6 wherein the control logic is operatively coupled to at least one speaker and to at least one microphone.

12. The electronic device of claim 6 wherein the control logic is operative to receive profile data associated with the second remote device and configures the plurality of control structures based on the profile data.

13. The electronic device of claim 6 further comprising a charging connector configured to connect to the second remote device.

14. An electronic device comprising:
a housing;
a short range wireless connection interface coupled to the housing for connecting with a remote device; and
a plurality of control keys, on one or more outer surfaces of the housing, to detect user input, wherein at least one of the plurality of control keys includes a visual light indication of connectivity status based on a connection occurring with a remote device via the short range wireless connection interface and based on a determined capability of the remote device.

15. The electronic device of claim 19 wherein a detection of user input by one or more of the plurality of control keys causes the electronic device to send a command to the remote device.

16. The electronic device of claim 15 wherein the sent command causes the remote device to do one of the following: play audio, play video, change a media source file answer a phone call, and place a phone call.

17. The electronic device of claim 14 wherein the short range wireless connection interface is capable of connecting with a second remote device; and
further wherein one or more of the plurality of control keys includes a visual light indication of connectivity status based on a connection occurring with the second remote device via the short range wireless connection interface and based on a determined capability of the second remote device.

18. The electronic device of claim 14 further comprising: a speaker and a microphone.
